(19) United States
(12) Patent Application Publication
(10) Pub. No.: US 2007/0054555 A1
(43) Pub. Date: Mar. 8, 2007

(54) Mobile phone holding device

(75) Inventor: Chung Yeh, Taipei City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/516,832

(22) Filed: Sep. 6, 2006

(30) Foreign Application Priority Data
Sep. 7, 2005 (TW) TW94130682

(51) Int. Cl. H01R 13/648

(52) U.S. Cl. 439/608

(57) ABSTRACT

A holding device for a mobile phone includes a base, an extending plate and a loading plate. The base is fastened on an arm. The extending plate is slidably joined to the base and slides between a first position and a second position, and loads a mobile phone. The loading plate is slidably disposed on the extending plate and slides between a third position and a fourth position. When the extending plate slides on the base, the loading plate slides on the extending plate. The moving direction of the loading plate is substantially opposite to and has an angle with respect to the moving direction of the extending plate.

### BACKGROUND

The invention relates to a holding device for a mobile phone, and in particular to a holding device configured for fastening to an arm of an operator capable of passing the mobile phone to the palm via an ejecting mechanism.

For the sake of health, exercise is often practiced. It is, however, inconvenient to carry a mobile phone during exercise.

### SUMMARY

An embodiment of a holding device of the invention comprises a base, an extending plate and a loading plate. The base is fastened to an arm of an operator. The extending plate is slidably joined to the base and slides between a first position and a second position to load a mobile phone. The loading plate is slidably disposed on the extending plate and slides between a third position and a fourth position. When the extending plate slides on the base, the loading plate slides on the extending plate. The moving direction of the loading plate is substantially opposite to and has an angle with respect to the moving direction of the extending plate.

The base comprises a main body and an extending plate sliding groove on two sides of the main body, and one edge of the extending plate is slidably disposed in the extending plate sliding groove.

The holding device further comprises a primary spring disposed between the base and the extending plate with ends abutting the base and the extending plate respectively, whereby force of the primary spring slides the extending plate on the base.

The base comprises at least a first primary spring groove, and the extending plate comprises a second primary spring groove corresponding to the first primary spring groove. When the extending plate joins to the base, the primary spring is constrained by the first and second primary spring grooves and positioned between the base and the extending plate.

The holding device further comprises a pin disposed between the base and the extending plate, wherein the extending plate is positioned between the first position and the second position. The pin is curved with one end positioned on the extending plate and the other end contacting the extending plate groove.

A pin groove is on the extending plate groove where one end of the pin slides.

The pin groove has a first recess and a second recess on two ends thereof, and when the pin enters the first recess, the extending plate is positioned in the first position, and when the pin enters the second recess, the extending plate is positioned in the second position.

The pin groove has a first groove connecting the first and second recesses and a second groove parallel to the first groove and connecting the first and second recesses; when the extending plate moves from the first position to the second position, the pin moves along the first groove from the first recess to the second recess, and when the extending plate moves from the second position to the first position, the pin moves from the second recess to the first recess along the second groove. The bottom of the first groove is lower than the bottom of the second groove at the first recess, and the bottom of the first groove is higher than the bottom of the second groove at the second recess. The base comprises a guiding block adjacent to the first recess and guiding the pin into the first groove.

The holding device further comprises a secondary spring disposed between the loading plate and the extending plate, whereby force of the secondary spring allows the loading plate to slide on the extending plate.

The holding device further comprises a sliding block joined to the loading plate. One end of the secondary spring is connected to the loading plate, and the other end of the secondary spring is connected to the sliding block, whereby force of the secondary spring allows the loading plate to slide on the extending plate. The extending plate has a sliding block groove where the sliding block slides, whereby the loading plate slides on the extending plate.

The holding device further comprises a fastening ring joined to the sliding block, wherein the secondary spring joins the fastening ring, whereby the secondary spring exerts force on the loading plate. The fastening ring is positioned between the extending plate and the base. The extending plate has a first post, and the fastening ring has a second post, two ends of the secondary spring are joined to the first post and the second post respectively, whereby force of the secondary spring moves the loading plate from the third position to the fourth position.

The base comprises a main body and a positioning plate disposed on the main body between the main body and the extending plate. The loading plate is positioned in the third position by the positioning plate constraining the sliding block. At this time the first post is separated from the positioning plate by a distance, whereby the secondary spring is stretched. The fastening ring has a plane abutting the positioning plate, whereby the positioning plate constrains the sliding block.

When the extending plate moves from the first position to the second position, the distance between the first post and the positioning plate shortens, whereby the secondary spring moves the loading plate from the third position to the fourth position. When the extending plate moves from the second position to the first position, the sliding block is constrained by the positioning plate to slide the loading plate from the fourth position to the third position.

The holding device comprises a fastening member fastening the base to the arm.

The loading plate has a plurality of hooks engaging the mobile phone, whereby the mobile phone is fixed to the loading plate.

### BRIEF DESCRIPTION OF THE DRAWINGS

The invention can be more fully understood by reading the subsequent detailed description and examples with references made to the accompanying drawings, wherein:

FIGS. 1 and 2 are schematic views of an embodiment of a holding device of the invention;

FIG. 3 is an exploded view showing the embodiment of FIG. 1;

FIG. 4a is a perspective view of the base of the embodiment of FIG. 1;

FIG. 4b depicts the structure of the pin groove of the embodiment of FIG. 1;

FIG. 5a is a perspective view of the extending plate of the embodiment of FIG. 1;

FIG. 5b is another perspective view of the extending plate of the embodiment of FIG. 1;

FIG. 6 is a perspective view of the loading plate of the embodiment of FIG. 1;

FIG. 7 is a perspective view of the pin of the embodiment of FIG. 1;

FIG. 8 is a perspective view of the fastening ring of the embodiment of FIG. 1;

FIG. 9 is a perspective view of the fastening member of the embodiment of FIG. 1;

FIG. 10a is a schematic view of the extending plate joined to the base;

FIG. 10b is an enlarged view of portion A of FIG. 10a;

FIG. 10c is a front view of FIG. 10b;

FIG. 11a is a schematic view showing the extending plate being pushed;

FIG. 11b is an enlarged view of portion A of FIG. 11a;

FIG. 11c is a front view of FIG. 11b;

FIG. 12 depicts the extending plate moving from the first position to the second position;

FIG. 13a depicts the extending plate positioned in the second position;

FIG. 13b is an enlarged view of portion B of FIG. 13a;

FIG. 13c is a front view of FIG. 13b;

FIG. 14a is a schematic view showing the extending plate being pushed back;

FIG. 14b is an enlarged view of portion B of FIG. 14a;

FIG. 15a is a schematic view showing the extending plate being pushed back to the first position;

FIG. 15b is an enlarged view of portion A of FIG. 15a;

FIG. 15c is a front view of FIG. 15b;

FIG. 16a is a schematic view showing the extending plate positioned in the first position;

FIG. 16b is a schematic view showing the pin entering the first recess;

FIG. 17 depicts the extending plate in the first position and the loading plate in the third position;

FIG. 18 is a schematic view of the extending plate moving to the fourth position.

### DETAILED DESCRIPTION

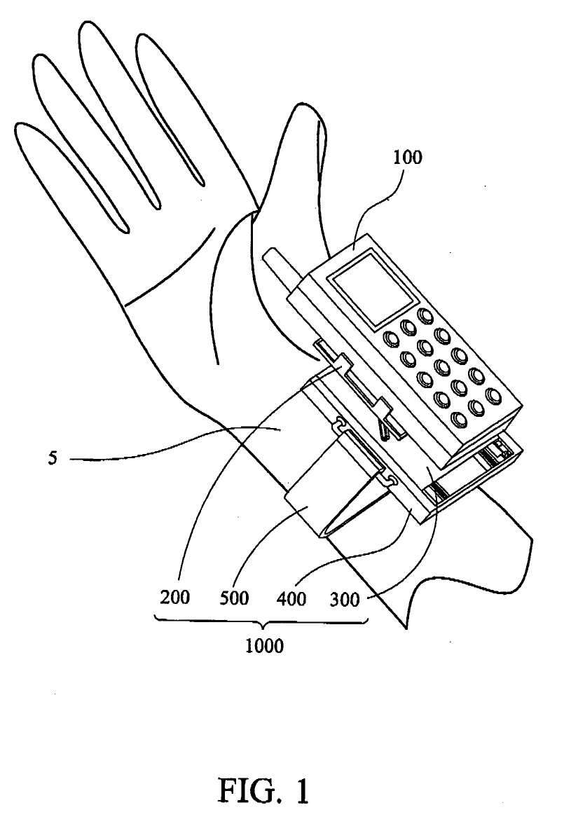

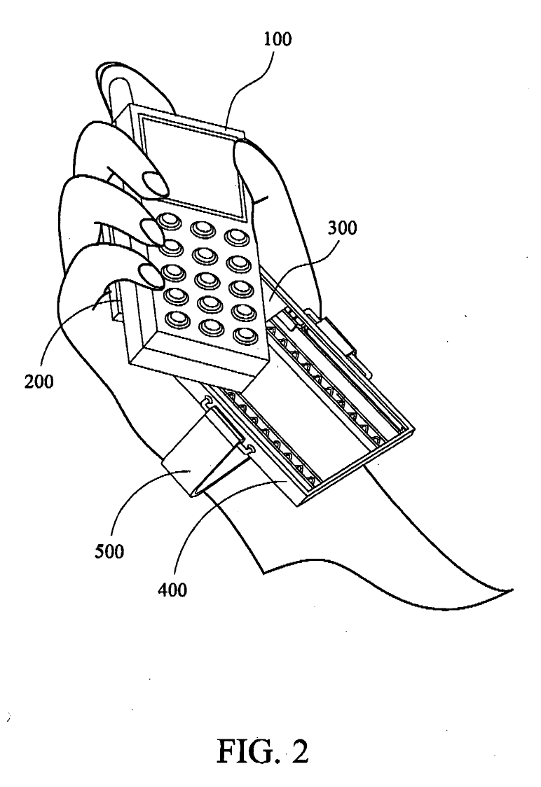

Referring to FIGS. 1 and 2, a mobile phone 100 is fastened to an arm 5 via a holding device 1000. When a call is incoming, the mobile phone 100 can slide to the palm and rotate by an angle, whereby the mobile phone 100 is easily held by the hand. The holding device 1000 comprises a loading plate 200, an extending plate 300, a base 400 and a fastening member 500. The loading plate 200 loads the mobile phone 100 and is slidably disposed on the extending plate 300. The extending plate 300 is slidably disposed on the base 400. The base 400 is fastened to the arm 5 via the fastening member 500. When a call is incoming, the extending plate 300 is pushed, whereby the extending plate 300 and the loading plate 200 eject toward the palm. During ejection, the loading plate 200 is rotated by an angle with respect to the extending plate 300, whereby the mobile phone 100 is easily held.

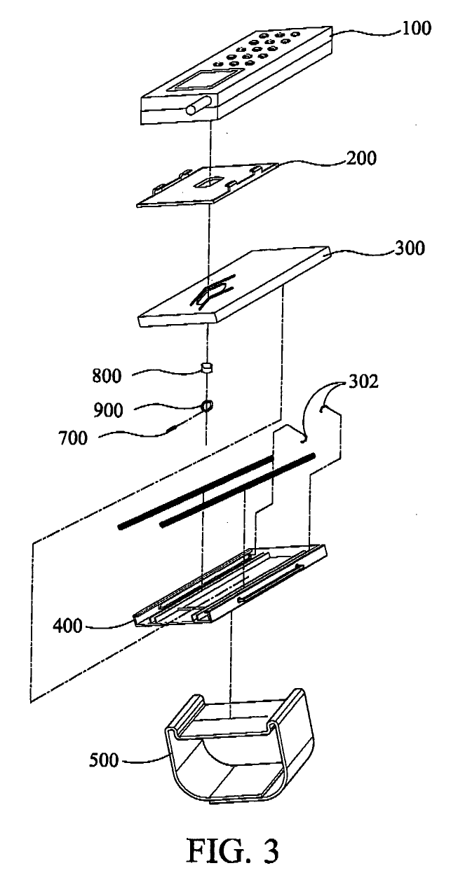

Referring to FIG. 3, the holding device 1000 further comprises two primary springs 600, a secondary spring 700, a pin 800 and a fastening ring 900. Elements of the holding device 1000 are described in the following.

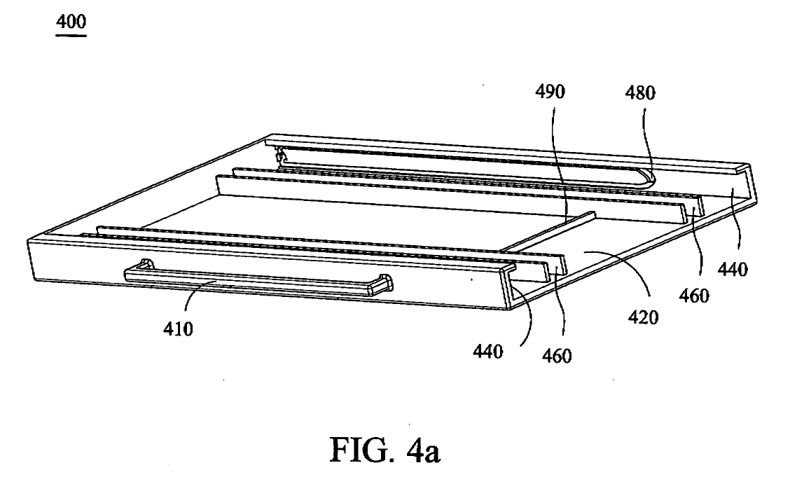

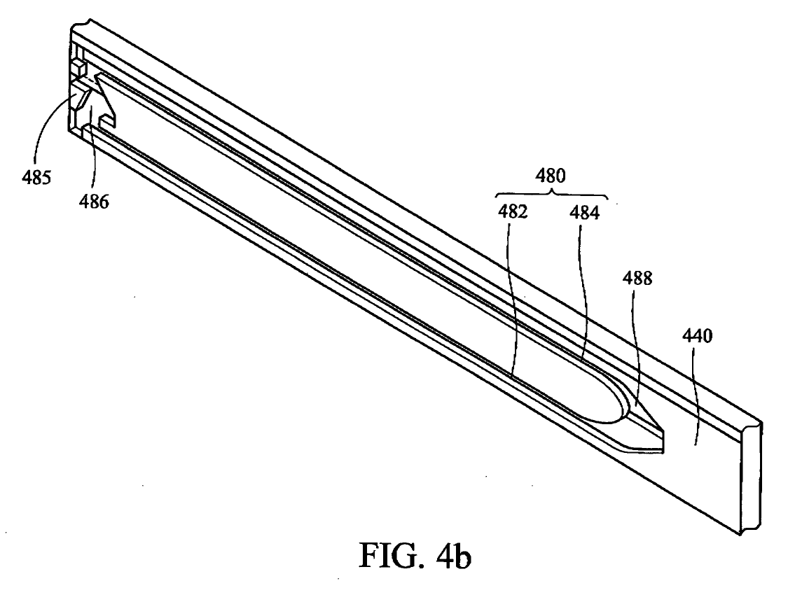

Referring to FIG. 4a, the base 400 comprises a main body 420, two extending plate grooves 440, two first primary spring grooves 460, two pin grooves 480 and a positioning plate 490. The main body 420 is substantially rectangular with one end opened to receive the extending plate 300 and the other end closed. The extending plate groove 440 which is C-shaped is formed on opposite sides of the main body 420. The first primary spring grooves 460 are formed on the main body 420, which is U-shaped and parallel to the extending plate grooves 440. The positioning plate 490 disposed on the main body 420 is perpendicular to the extending plate grooves 440 and primary spring grooves 460. In FIG. 4b, the pin grooves 480 are formed in the extending plate grooves 440. Each pin groove 480 comprises a first groove 482 and a second groove 484. A first recess 486 and a second recess 488 are formed on two ends of the pin groove 480. The first groove 482 and the second groove 484 are parallel and connect the first recess 486 and the second recess 488 respectively. The bottom of the first groove 482 is lower than the bottom of the second groove 484 in the first recess 486. The bottom of the first groove 482 is higher than the bottom of the second groove 484 in the second recess 488. A guide block 485 is disposed near the first recess 486.

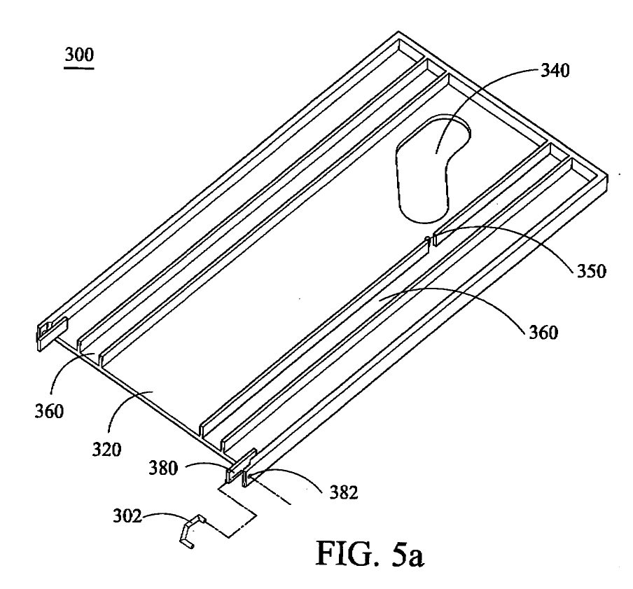

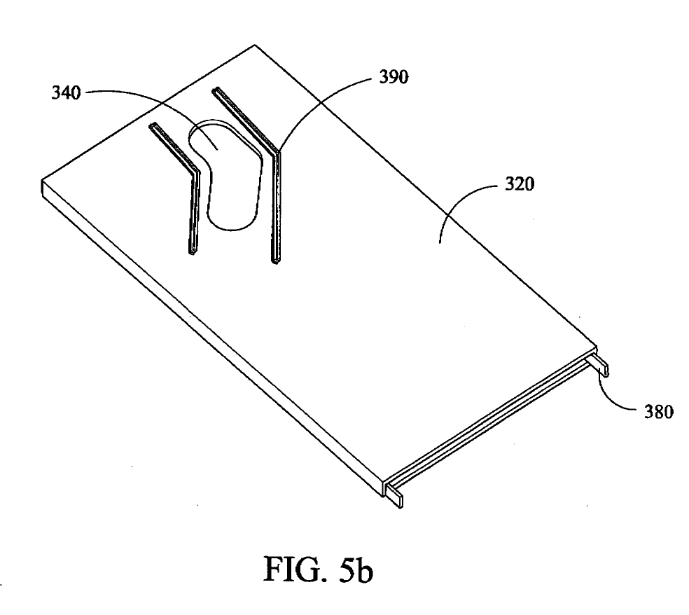

Referring to FIGS. 5a and 5b, the extending plate 300 comprises a main body 320, a sliding block groove 340, a first post 350, two second primary spring grooves 360, two tabs 380, two mounting holes 382 and a rail 390. The sliding block groove 340 is formed on the main body 320 and is substantially V-shaped for receiving the sliding block 800. The first post 350 is provided for positioning the secondary spring 700. The second primary spring groove 360 corresponds to the primary spring groove 460. When the extending plate 300 joins to the base 400, the first and second primary spring grooves 460 and 360 are engaged, whereby the primary spring 600 is positioned between the extending plate 300 and the base 400. The pin 302 is disposed between the tab 380 and a lateral wall of the main body 320. The pin 302 is curved with one end engaging the mounting hole 382 and the other end sliding in the pin groove 480. The rail 390 is provided for guiding the loading plate 200.

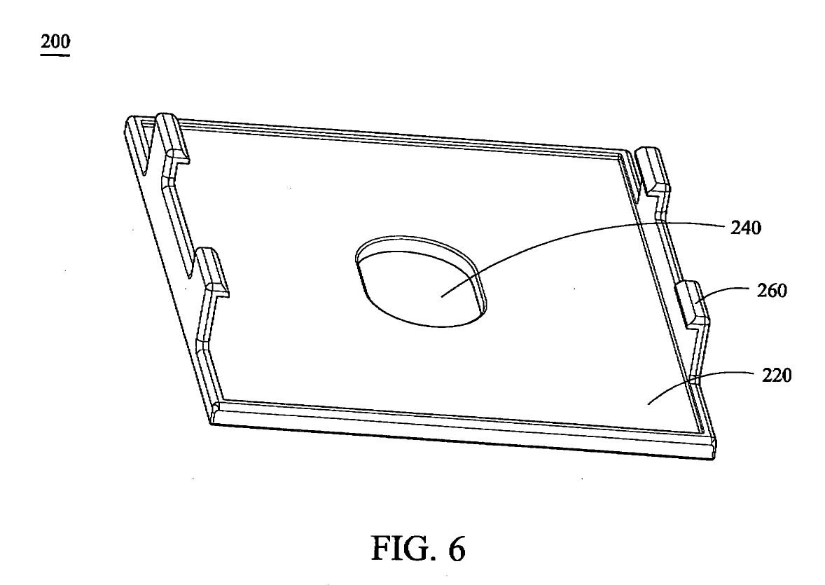

Referring to FIG. 6, the loading plate 200 comprises a square main body 220, a block hole 240 and four hooks 260. The block hole 240 is substantially elliptical and disposed at the center of the main body 220 to receive the sliding block 800. Four hooks 260 are disposed on opposite sides of the main body 220 to hold the mobile phone 100.

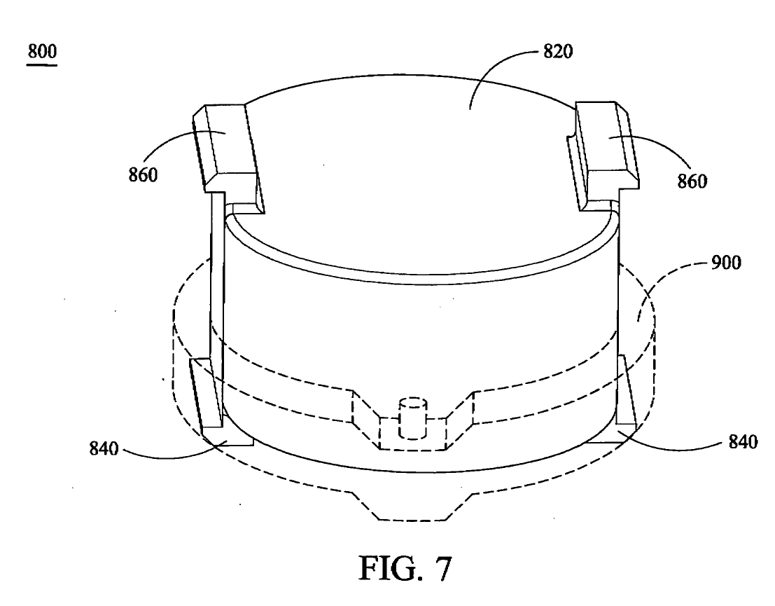

Referring to FIGS. 7 and 8, the sliding block 800 comprises a main body 820, two first hooks 840 and two second hooks 860. The main body 820 is substantially an ellipsoid. The first hook 840 and the second hook 860 are disposed on the opposite ends thereof. The fastening ring 900 comprises an elliptical main body 920, a second post 940 and a plane 960. The main body 920 has a recess 922 where the second post 940 is disposed. The plane 960 is adjacent to the recess 922.

As shown by the dashed line in FIG. 7, the fastening ring 900 is joined to sliding block 800 via the first hook 840. The second hook 860 extends through the sliding block groove 340 and engages the block hole 240. The secondary spring 700 is an extension spring with one end joining the first post 350 and the other end joining the second post 940. The force of the secondary spring 700 allows the sliding block 800 to slide in the sliding block groove 340, whereby the loading plate 200 is slidable on the extending plate 300.

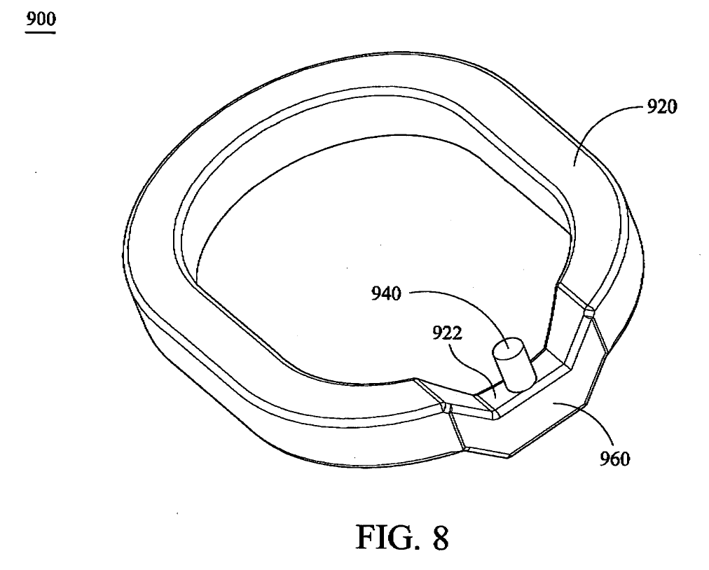

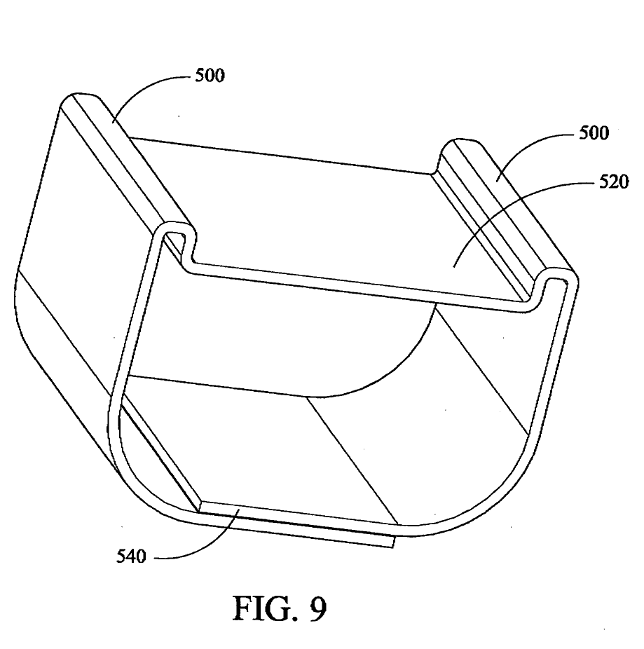

Referring to FIG. 9, the fastening member 500 is a strip-like body and has an accommodating portion 520 accommodating the base 400. Ends of the fastening member 500 pass through lugs 410 (referring to FIG. 4a) of the base 400, whereby the fastening member 500 encircles the arm. The ends of the fastening member 500 have a bonding area 540 where the ends thereof are bonded together. The bonding area 540 is provided with Velcro.

The following paragraphs describe the functions and motions of the holding device.

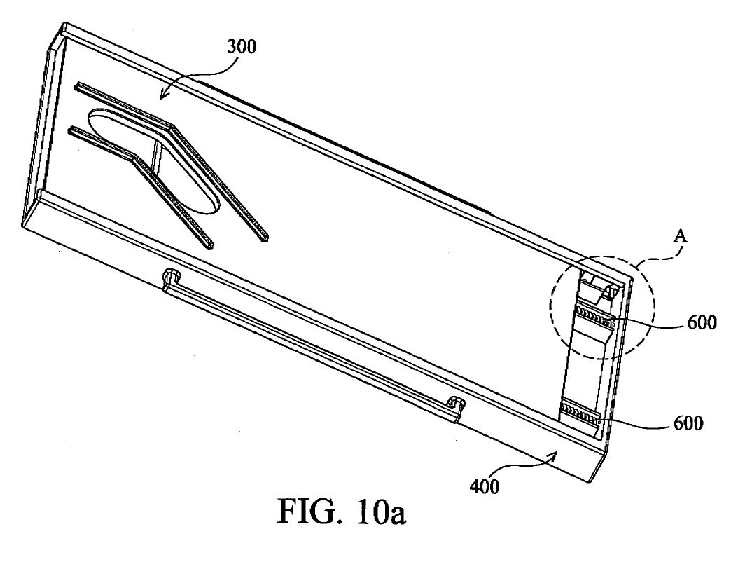

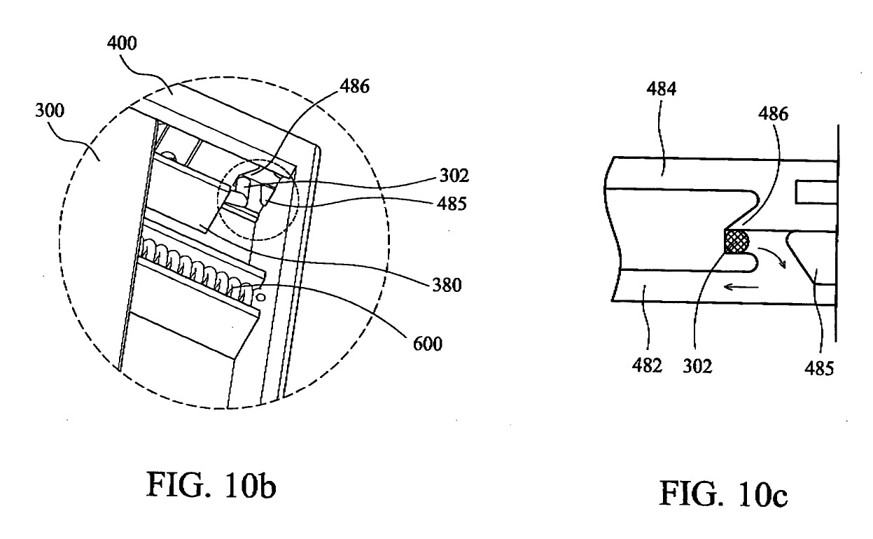

Referring to FIG. 10a, two primary springs 600 are constrained in the first and second primary spring grooves 460 and 360. One end of the pin 302 enters the first recess 486. At this time, the extending plate 300 is in the first position. FIG. 10b is an enlarged view of portion A of FIG. 10a. FIG. 10c is a front view of FIG. 10b. The pin 302 engages the first recess 486, whereby the extending plate 300 is constrained in the first position by the base 400 with the primary spring 600 being compressed and biasing the extending plate 300.

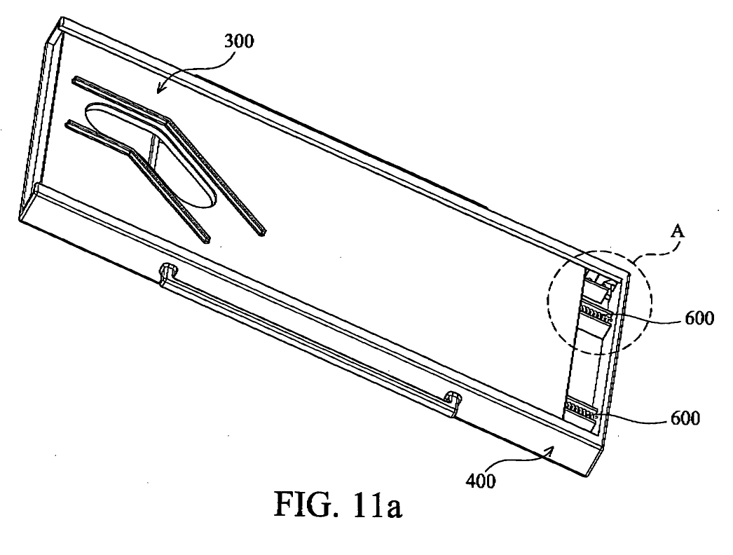

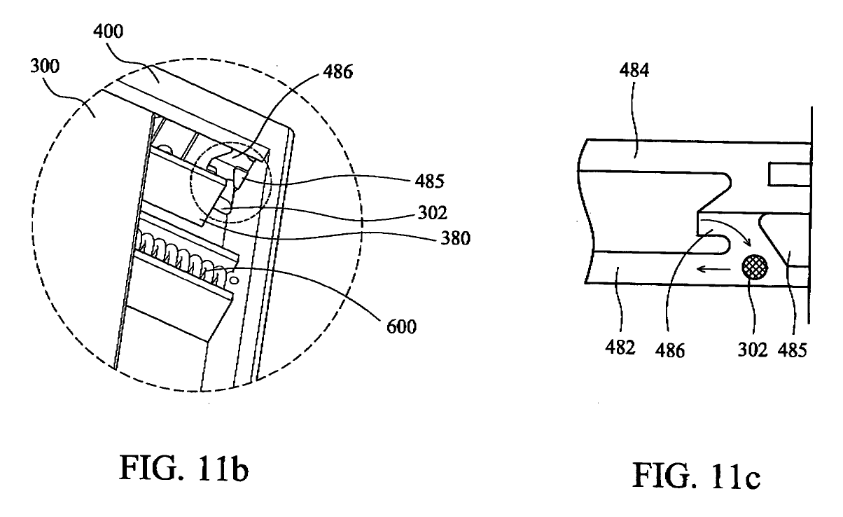

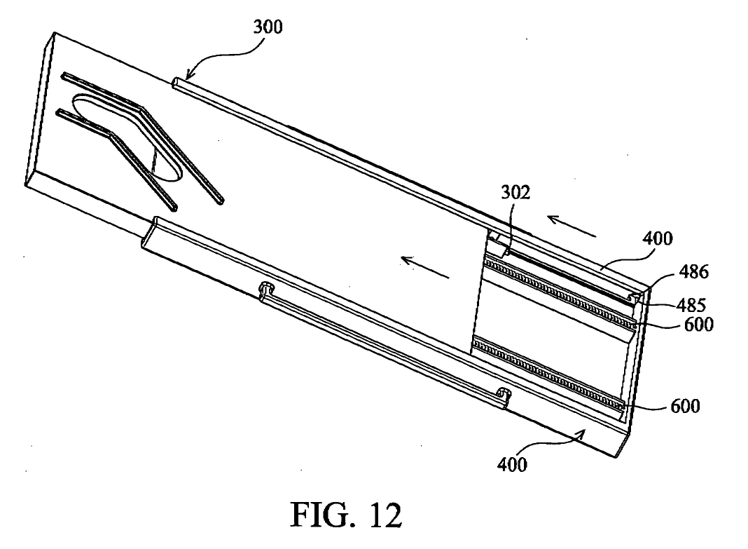

Referring to FIGS. 11a, 11b and 11c, when the extending plate 300 is pulled back, the pin 302 moves back. As the first groove 482 and the second groove 484 have different heights (the second groove 484 is higher than the first groove 482), the pin 302 enters the first groove 482 via the guiding block 485. At this time, the extending plate 300 is released from the base 400, and force of the primary spring 600 pushes the extending plate 300 forward, as shown in FIG. 12.

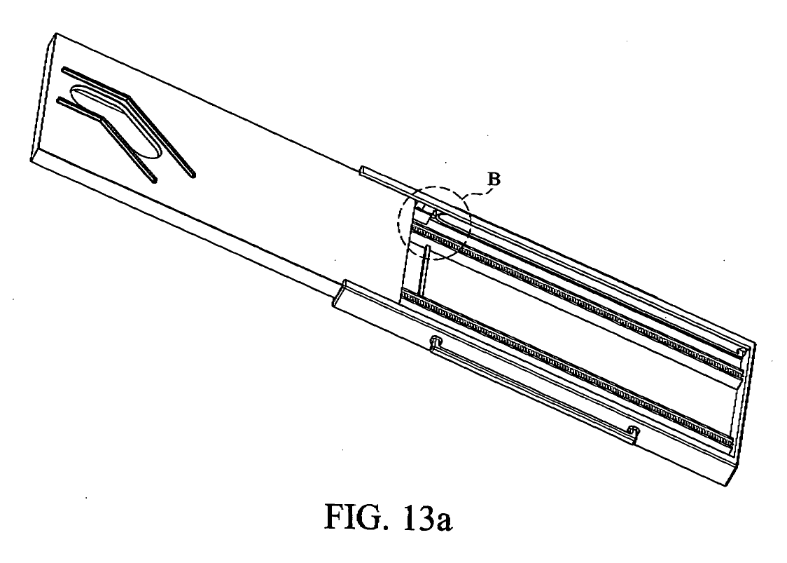

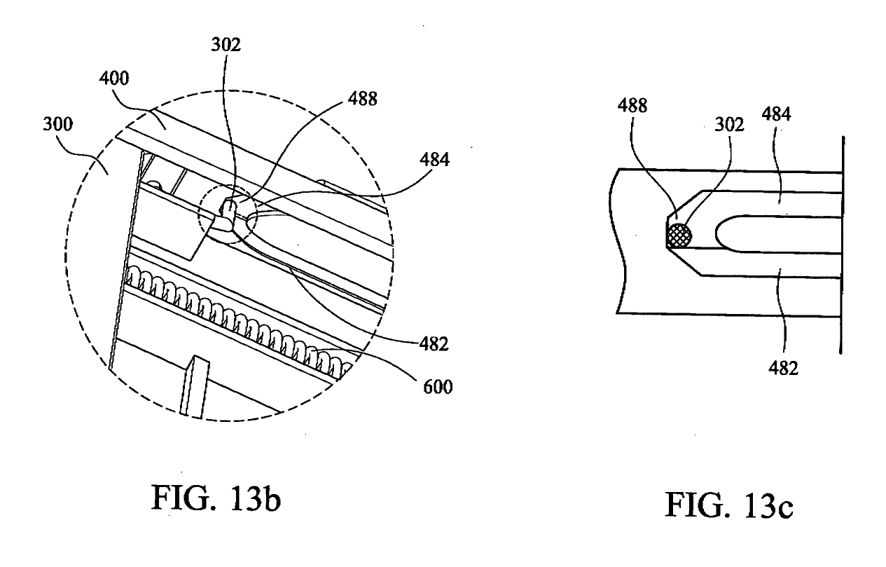

When the extending plate 300 slides to the second position as shown in FIG. 13a, the pin 302 enters the second recess 488 where the pin 302 is constrained by the step which is formed by the height difference of the first groove 482 and the second groove 484 (the first groove 482 is higher than the second groove 484) and positioned in the second recess 488 as shown in FIGS. 13b and 13c.

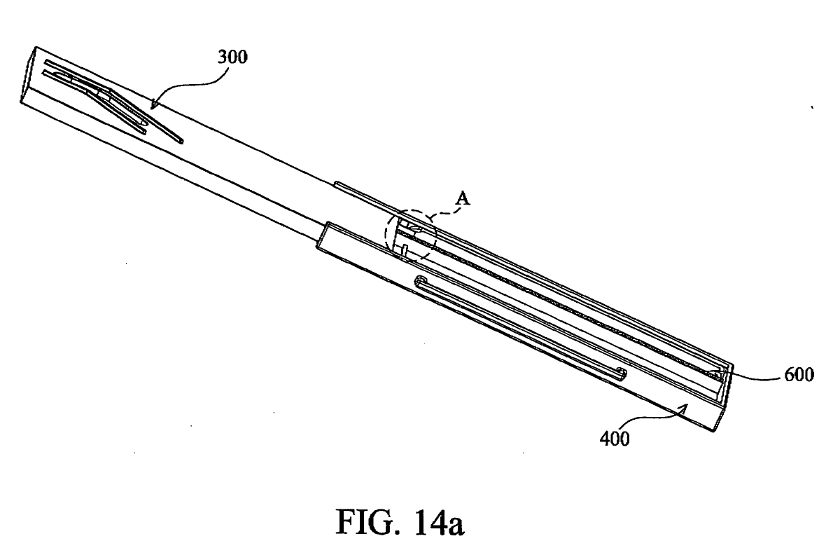

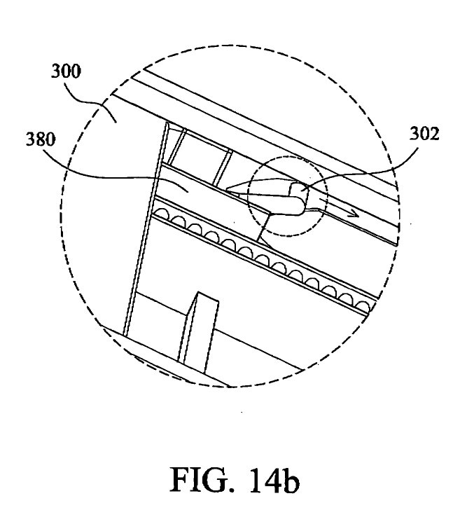

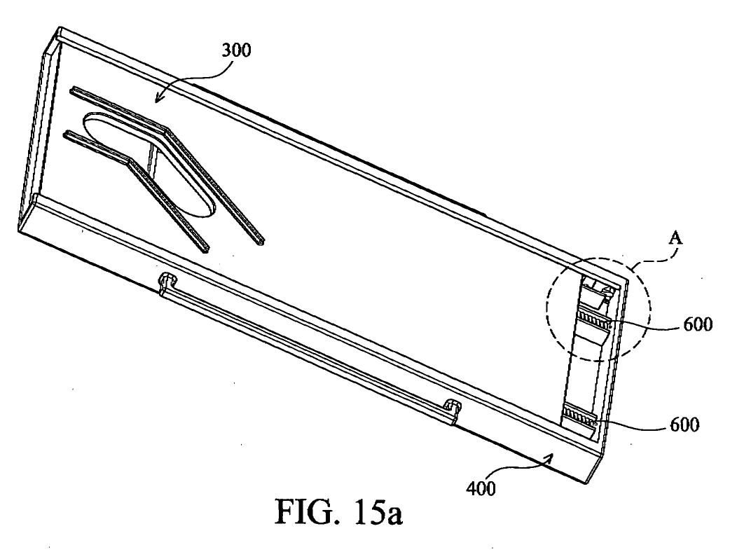

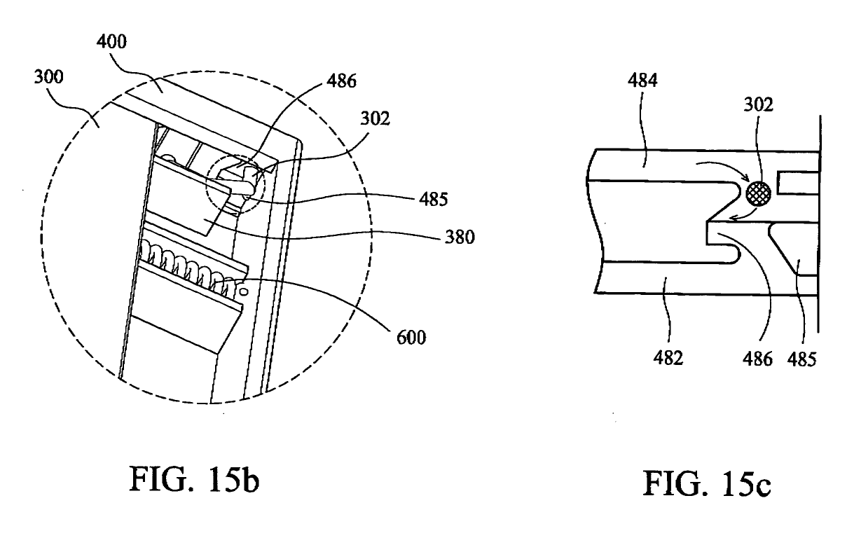

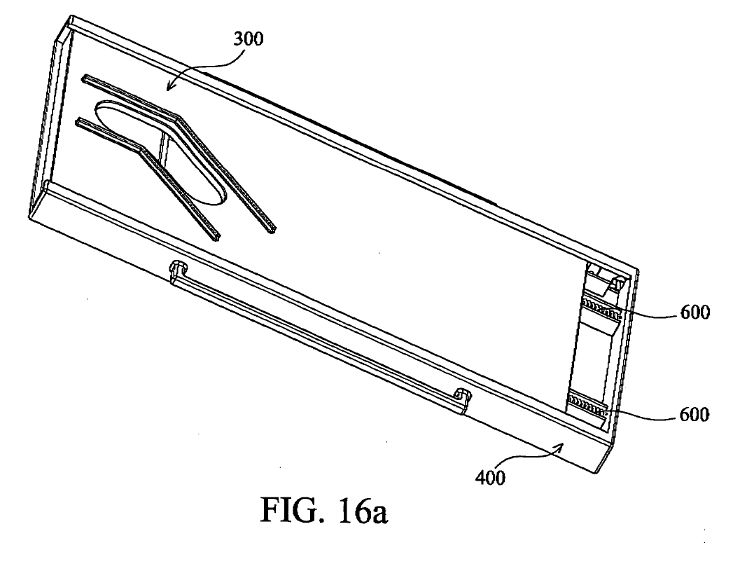

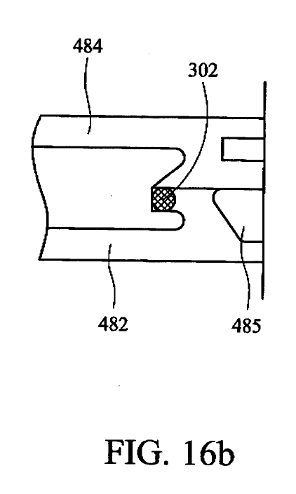

When the extending plate 300 is pushed back as shown in FIG. 14a, the pin 302 slides along the second groove 484 as shown in FIG. 14b and the extending plate 300 moves from the second position to the first position as shown in FIGS. 15a, 15b and 15c. When the pin 302 enters the first recess 486, the extending plate 300 is constrained by the base 400 to the first position as shown in FIGS. 16a and 16b.

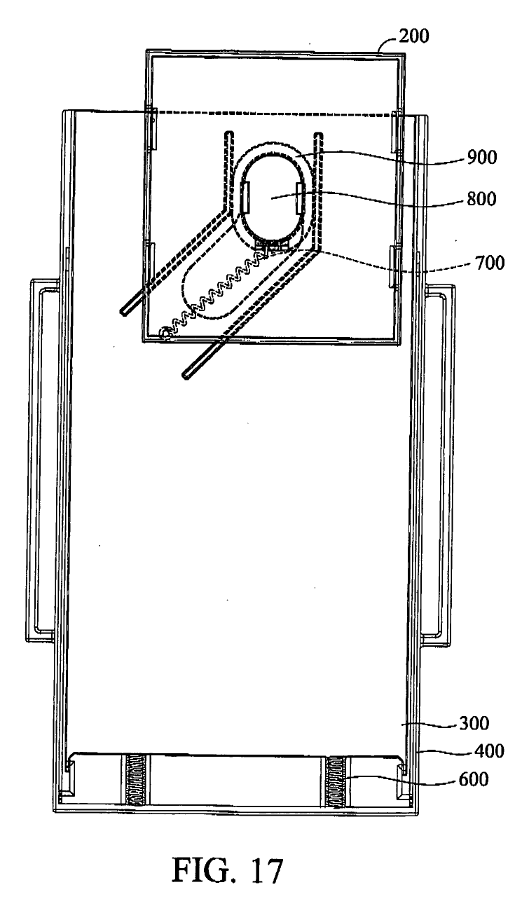

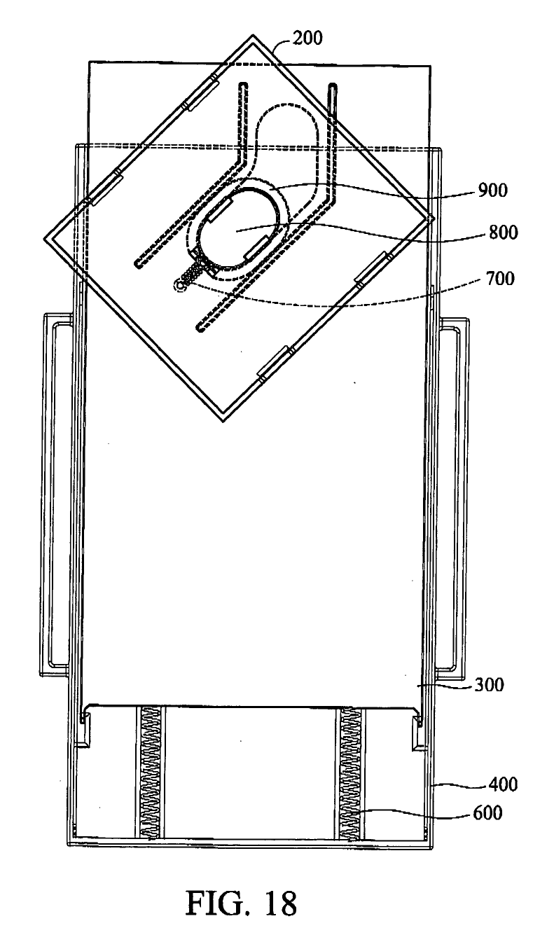

When the extending plate 300 is in the first position, the plane 960 of the fastening ring 900 abuts the positioning plate 490 of the base 400, as shown in FIGS. 4a, 8 and 17. At this time, the second post 940 is near the positioning plate 490, and the first post 350 is separated from the positioning plate 490 by a distance. The secondary spring 700 is stretched, as shown in FIG. 17.

When the extending plate 300 is pushed by the primary spring 600, the first post 350 moves toward the positioning plate 490. At this time, the sliding block groove 340 moves relative to the sliding block 800, whereby the sliding block 800 is rotated and the loading plate 200 is pulled to the fourth position by the secondary spring 700. When the first post 350 exceeds the positioning plate 490, the fastening ring 800 is pulled to a predetermined position by the secondary spring 700. At this time, the loading plate 200 is positioned in the fourth position.

When pushed, the extending plate 300 ejects out, and the loading plate 200 rotates by an angle. When the ejected extending plate 300 is pushed back, the loading plate 200 is rotated to the original position parallel to the extending plate 300.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A holding device for a mobile phone, comprising:
a base capable of being fastened to an arm;
an extending plate slidably joined to the base and slidable between a first position and a second position; and
a loading plate for loading the mobile phone, slidably disposed on the extending plate and slidable between a third position and a fourth position, wherein when the extending plate slides on the base, the loading plate slides on the extending plate with the moving direction of the loading plate substantially opposite to and having an angle with respect to the moving direction of the extending plate.

2. The holding device as claimed in claim 1, wherein the base comprises a main body and an extending plate sliding groove on two sides of the main body, and one edge of the extending plate is slidably disposed in the extending plate sliding groove.

3. The holding device as claimed in claim 2, further comprising a primary spring disposed between the base and the extending plate with ends abutting the base and the extending plate respectively, whereby force of the primary spring allows the extending plate to slide on the base.

4. The holding device as claimed in claim 3, wherein the base comprises at least a first primary spring groove, and the extending plate comprises a second primary spring groove corresponding to the first primary spring groove; when the extending plate is joined to the base, the primary spring is constrained by the first and second primary spring grooves and positioned between the base and the extending plate.

5. The holding device as claimed in claim 3, further comprising a pin disposed between the base and the extending plate, wherein the extending plate is positioned between the first position and the second position by the pin.

6. The holding device as claimed in claim 5, wherein the pin is curved with one end positioned on the extending plate and the other end making contact the extending plate groove.

7. The holding device as claimed in claim 6, wherein a pin groove is defined on the extending plate groove where one end of the pin slides.

8. The holding device as claimed in claim 7, wherein the pin groove has a first recess and a second recess defined on two ends thereof, and when the pin enters the first recess, the extending plate is positioned in the first position, and when the pin enters the second recess, the extending plate is positioned in the second position.

9. The holding device as claimed in claim 8, wherein the pin groove has a first groove portion connecting the first and second recesses and a second groove portion, parallel to the first groove portion, connecting the first and second recesses; when the extending plate moves from the first position to the second position, the pin moves along the first groove portion from the first recess to the second recess, and when the extending plate moves from the second position to the first position, the pin moves from the second recess to the first recess along the second groove portion.

10. The holding device as claimed in claim 9, wherein the bottom of the first groove portion is lower than the bottom of the second groove portion at the first recess, and the bottom of the first groove portion is higher than the bottom of the second groove portion at the second recess.

11. The holding device as claimed in claim 9, wherein the base comprises a guiding block adjacent to the first recess for guiding the pin into the first groove portion.

12. The holding device as claimed in claim 1, further comprising a secondary spring disposed between the loading plate and the extending plate, whereby force of the secondary spring allows the loading plate to slide on the extending plate.

13. The holding device as claimed in claim 12, further comprising a sliding block joined to the loading plate, wherein one end of the secondary spring is connected to the loading plate, and the other end of the secondary spring is connected to the sliding block, whereby force of the secondary spring allows the loading plate to slide on the extending plate.

14. The holding plate as claimed in claim 13, wherein the extending plate has a sliding block groove where the sliding block slides, whereby the loading plate slides on the extending plate.

15. The holding device as claimed in claim 14, further comprising a fastening ring joined to the sliding block, wherein the secondary spring joins the fastening ring, whereby the secondary spring exerts force on the loading plate.

16. The holding device as claimed in claim 15, wherein the fastening ring is positioned between the extending plate and the base.

17. The holding plate as claimed in claim 16, wherein the extending plate has a first post and the fastening ring has a second post, two ends of the secondary spring are joined to the first post and the second post respectively, whereby force of the secondary spring moves the loading plate from the third position to the fourth position.

18. The holding device as claimed in claim 17, wherein the base comprises a main body and a positioning plate disposed on the main body between the main body and the extending plate, and the loading plate is positioned in the third position by the positioning plate constraining the sliding block, at this time the first post is separated from the positioning plate by a distance, whereby the secondary spring is stretched.

19. The holding device as claimed in claim 18, wherein the fastening ring has a plane abutting the positioning plate, whereby the positioning plate constrains the sliding block.

20. The holding device as claimed in claim 18, wherein when the extending plate moves from the first position to the second position, the distance between the first post and the positioning plate shortens, whereby the secondary spring moves the loading plate from the third position to the fourth position; when the extending plate moves from the second position to the first position, the sliding block is constrained by the positioning plate to slide the loading plate from the fourth position to the third position.
